(19) United States
(12) Patent Application Publication
(10) Pub. No.: US 2016/0050163 A1
(43) Pub. Date: Feb. 18, 2016

(54) Mail Data Transmission System and Transmission Method

(71) Applicant: BENQ CORPORATION, Taipei (TW)

(72) Inventor: Chen-Chi Wu, Taipei (TW)

(21) Appl. No.: 14/817,224

(22) Filed: Aug. 4, 2015

(30) Foreign Application Priority Data
Aug. 14, 2014 (TW) 103127960

(51) Int. Cl. H04L 12/58; H04L 29/12; H04L 29/06

(52) U.S. Cl. CPC H04L 51/00; H04L 67/42; H04L 61/20

(57) ABSTRACT

A method of transmitting mail data includes inputting a first client terminal address to a network electronic device, assigning a mail server address to the network electronic device under a simple mail transfer protocol, inputting a second client terminal address to the network electronic device, transmitting mail data from the first client terminal address of the network electronic device to a relay server corresponding to a relay server address, transmitting the mail data to a mail server corresponding to the mail server address from the relay server, and transmitting the mail data to the second client terminal address from the mail server.

### BACKGROUND OF THE INVENTION

1. Field of the Invention

The present invention illustrates a mail data transmission system and a transmission method, and more particularly, the transmission method by using a relay server.

2. Description of the Prior Art

With the advancement of network techniques, various electronic mail data can be transmitted to a specific destination for delivering real-time information through a wireless or wire-based network. Specifically, when an electronic mail function is applied to a network electronic device, the mail data of a user with respect to the network electronic device can be transmitted to an external device through the network. Further, a status and/or an error log message of the network electronic device can be also reported to an administrator. Thus, the administrator can deal with an error or abnormal status of the network electronic device immediately by remote monitoring of the network electronic device.

Generally, a conventional method for transmitting mail data from the network electronic device is illustrated below. First, the mail data is transmitted from a subscriber client terminal of the network electronic device to a mail server under a simple mail transfer protocol (SMTP). Further, the mail data is transmitted to the administrator by using the mail server. Several popular mail servers with SMTP are considered as Gmail server, Hotmail server, Hinet server, or Yahoo server. Particularly, to avoid an illegal data accessing by hackers, various security verification methods are introduced and further applied to the mail servers for increasing the security level of data transmission. Additionally, some encryption and decryption mechanisms are also introduced to protect the security of a user log-in account and password information. Specifically, since several encryption and decryption mechanisms are applied to the mail server, the subscriber client terminal of the network electronic device has to use corresponding (i.e., or say, same definition from a standard) encryption and decryption mechanisms. By doing so, the mail data transmitted from the network electronic device to the administrator through the mail server can remain an encrypted status throughout. As a result, when the mail data is accessed illegally by hackers, since the mail data is encrypted, the information of the mail data cannot be extracted directly. Since the encryption mechanism is a mandatory and necessary issue for the mail data transmission, the mail data transmission with encryption technique is already incorporated to a network security standard.

However, the methods of security verification and the encryption mechanisms are updated over time. When the encryption mechanism of the mail server is updated, if the network electronic device fails to match the updated encryption mechanisms from a database, the mail server may interrupt a link to the network electronic device. Thus, in an early model-typed network electronic device or a network electronic device with antiquated database of the encryption mechanism, when the mail data is transmitted from the network electronic device to the mail server, information of the mail data may be lost since the link between the mail server and the network electronic device is terminated. Conventionally, to solve this problem, firmware of the network electronic device and the database of encryption mechanism have to be updated synchronously. Thus, heavy time consumption and maintenance effort are required in conventional network electronic device.

Thus, to develop a network electronic device without requiring any modification of the firmware and the database of encryption mechanism in conjunction with high mail data delivery reliability is important.

### SUMMARY OF THE INVENTION

In an embodiment of the present invention, a mail data transmission method is disclosed. The mail data transmission method includes inputting a first client terminal address to a network electronic device, assigning a mail server address to the network electronic device under the simple mail transfer protocol, inputting a second client terminal address to the network electronic device, transmitting mail data from the first client terminal address of the network electronic device to a relay server corresponding to a relay server address, transmitting the mail data to a mail server corresponding to the mail server address from the relay server, and transmitting the mail data to the second client terminal address from the mail server.

In another embodiment of the present invention, a mail data transmission system is disclosed. The mail data transmission system includes a network electronic device having an input interface for inputting information, a relay server linked to the network electronic device, and a plurality of mail servers, each mail server of the plurality of mail servers being linked to the relay server, wherein mail data is transmitted from a first client terminal address of the network electronic device to the relay server, an encryption process is performed on the mail data by the relay server to generate encrypted mail data according to an encryption standard of the mail servers, the encrypted mail data is transmitted to a mail server of the mail servers from the relay server, the encrypted mail data is transmitted to a second client terminal address from the mail server.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a system structure of a mail data transmission system according to a first embodiment of the present invention.

FIG. 2 illustrates a user interface of a network electronic device in FIG. 1.

FIG. 3 illustrates a system structure of a mail data transmission system according to a second embodiment of the present invention.

FIG. 4 illustrates a user interface of the network electronic device in FIG. 3.

### DETAILED DESCRIPTION

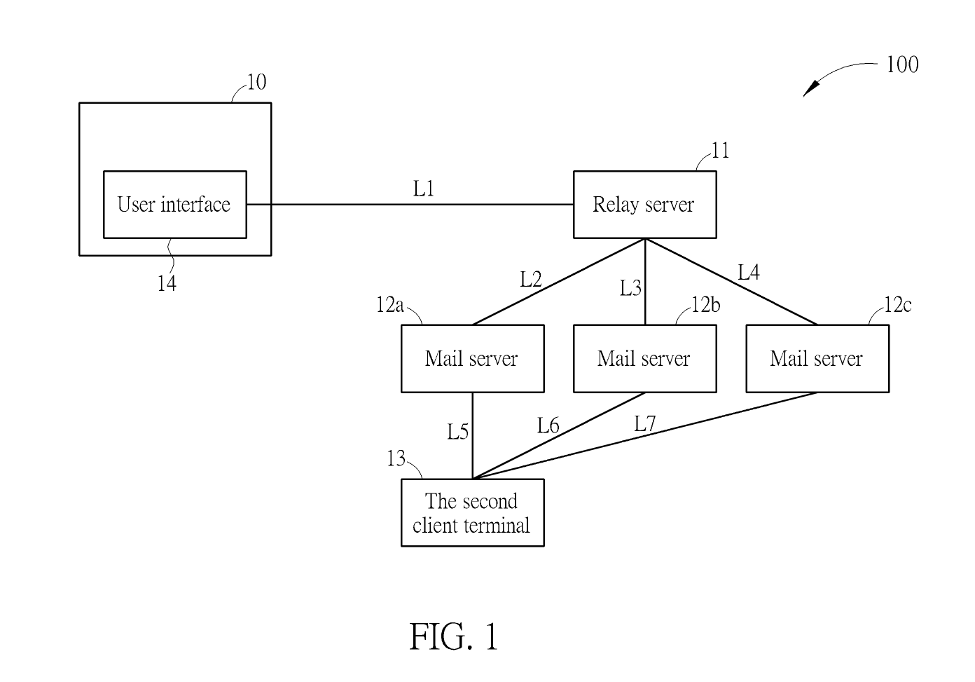

FIG. 1 illustrates a system structure of a mail data transmission system 100 according to a first embodiment of the present invention. As shown in FIG. 1, the mail data transmission system 100 includes a network electronic device 10, a relay server 11, several mail servers 12a, 12b, and 12c, and a second client terminal 13. The network electronic device 10 includes a user interface 14. Specifically, the relay server 11 is linked to the network electronic device 10 through a link L1. The mail server 12a is linked to the relay server 11 through a link L2. The mail server 12b is linked to the relay server 11 through a link L3. The mail server 12c is linked to the relay server 11 through a link L4. Further, the mail server 12a is linked to the second client terminal 13 through a link L5. The mail server 12b is linked to the second client terminal 13 through a link L6. The mail server 12c is linked to the second client terminal 13 through a link L7. In the embodiment, the mail servers 12a, 12b, and 12c can be considered as a Hotmail server, a Gmail server, or a Hinet server. The Hotmail server, the Gmail server, or the Hinet server is linked to a client terminal (i.e., or say, PC terminal of the subscriber). In the mail data transmission system 100, a mail data can be transmitted from the network electronic device 10 to a specific mail server through the relay server 11 by passing through the link L1 and one of the links L2 to L4 according to the information inputted to the user interface 14 of the network electronic device 10. After the mail data is received by the mail server, the mail data is transmitted to the second client terminal 13 through a corresponding link. For example, the mail data is transmitted from the network electronic device 10 to the relay server 11 through the link L1. The relay server 11 transmits the mail data to the mail server 12a (i.e., the mail server to be logged-in) through a link L2. Then, the mail server 12a transmits the mail data to the second client terminal 13 through a link L5. Here, the relay server 11 performs the mail data transmission under a simple mail transfer protocol (SMTP) so that the relay server 11 can be regarded as an SMTP-Relay-Server. Similarly, several mail servers 12a, 12b, and 12c also perform mail data transmission under SMTP so that they can be regarded as SMTP-Mail-Servers. Specifically, the network electronic device 10 can be a network projector in the embodiment. However, the network electronic device 10 is not limited by the network projector in the present invention. For example, the network electronic device 10 can be arbitrary type of electronic device having a capability for accessing network. For presentation convenience, nomenclatures of the relay server 11 and the mail servers 12a, 12b, and 12c are maintained in the following literature. Configurations of the user interface 14 and the method for transmitting the mail data of the network electronic device 10 in the mail data transmission system 100 are illustrated below.

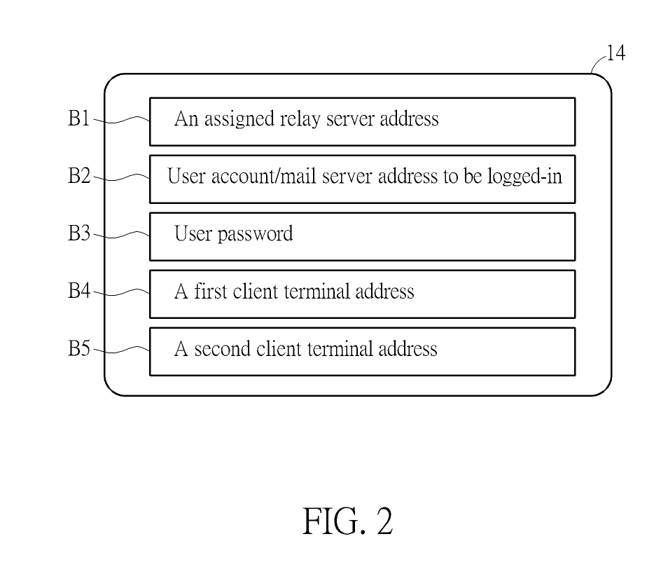

FIG. 2 illustrates the user interface 14 of the network electronic device 10 in FIG. 1. As shown in FIG. 2, the user interface 14 includes 5 input windows, as an input window B1, an input window B2, an input window B3, an input window B4, and an input window B5. These 5 input windows B1 to B5 can receive string information from user input. Here, the string information may include at least one character and/or at least one number. In the embodiment, the network electronic device 10 is considered as an early model-typed network electronic device with 5 input windows B1 to B5. Specifically, in order to apply the network electronic device 10 to the mail data transmission system 100, 5 input windows B1 to B5 of the user interface 14 are required to input the following information. The input window B1 is required to input a network address of a relay server 11. For example, “benq.smtp-relay.com” is inputted to the input window B1. The input window B2 is required to input a user (i.e., or say, a first client/subscriber) account information in conjunction with a network address of a mail server to be logged-in. For example, “peter/msa.hinet.net” is inputted to the input window B2. Particularly, in the embodiment, the user account information and the network address of the mail server of the input window B2 are partitioned by a symbol “/”. However, the present invention is not limited to using the symbol “/” for partitioning the user account information and the network address of the mail server in an input string of the input window B2. For example, other embodiments can use an arbitrary symbol(s) for partitioning the user account information and the network address of the mail server in an input string of the input window B2. The input window B3 is required to input the user (i.e., or say, the first client/subscriber) password. For example, “peter19770605” is inputted to the input window B3. The input window B4 is required to input a first client terminal address. The first client terminal address can be an E-mail address of the first client. For example, “system@projector.com” is inputted to the input window B4. The input window B5 is required to input a second client terminal address. The second client terminal address can be an E-mail address of the second client. For example, “Anderson.homer@its.biohazard.com” is inputted to the input window B5.

In the following, the method for transmitting the mail data of the mail data transmission system 100 is illustrated. First, 5 input windows B1 to B5 of the user interface 14 are required to input the corresponding information described above. Thus, the network electronic device 10 receives a relay server address assigned by a first client (user), a user account information/a network address of a mail server, a user password, a first client terminal address, and a second client terminal address from the user interface 14. Here, in FIG. 1, the network electronic device 10 transmits the mail data to the relay server 11 corresponding to the relay server address through a link L1. The relay server 11 transmits the received mail data to a mail server corresponding to the mail server address. For example, an active mail server to be logged-in with a corresponding mail server address “msa.hinet.net” is used. Then, the relay server 11 transmits the received mail data to a Hinet mail server (i.e., the mail server 12a) through a link L2. Finally, the mail server 12a transmits the mail data to a second client terminal 13 through a link L5. Here, since the network electronic device 10 is an early model-typed network electronic device, the database of the encryption/decryption mechanism is antiquated. If the network electronic device 10 establishes a link and transmits the mail data to the mail server 12a directly, information of the mail data may be lost since the link between the mail server 12a and the network electronic device 10 may be interrupted, terminated, or forbidden. In the embodiment, the mail data is transmitted from the network electronic device 10 to the relay server 11 first. The relay server 11 executes an encryption process to the mail data before the mail data is transmitted to the mail server 12a corresponding to the mail server address by the relay server 11, wherein the encryption process is defined according to an encryption standard of the mail server 12a. Thus, when the relay server 11 transmits an encrypted mail data to the mail server 12a, the mail data can be completely received by the mail server 12a without any information loss since the security mechanisms between the relay server 11 and the mail server 12a are matched. Finally, the mail server 12a transmits the encrypted mail data to the second client terminal 13. In the embodiment, although the network electronic device 10 is the early model-typed network electronic device, the network electronic device 10 can transmit the mail data without requiring any modification of the firmware and the database of encryption mechanism in conjunction with high mail data delivery reliability. Additionally, although the number of mail servers in the mail data transmission system 100 is equal to 3, the number of mail servers in the mail data transmission system is not limited to 3 in the present invention. For example, in other embodiments, the number of mail servers in the mail data transmission system is equal to N, wherein N is a positive integer.

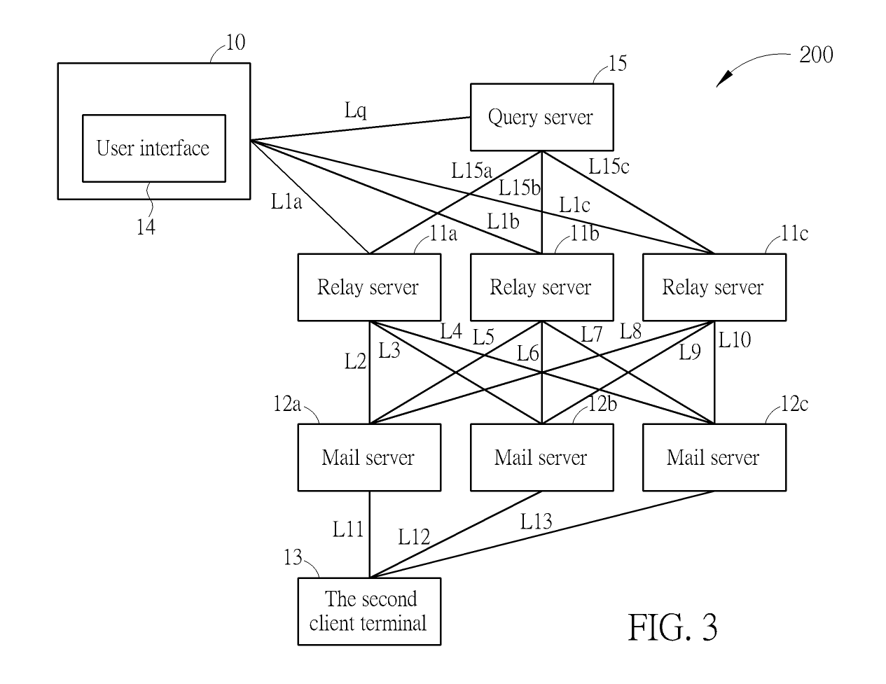

FIG. 3 illustrates a system structure of a mail data transmission system 200 according to a second embodiment of the present invention. As shown in FIG. 3, the mail data transmission system 200 includes a network electronic device 10, several relay servers 11a, 11b, and 11c, several mail servers 12a, 12b, and 12c, a second terminal 13, and a query server 15. The network electronic device 10 includes a user interface 14. The relay servers 11a, 11b, and 11c are linked to the network electronic device 10 respectively. In FIG. 3, the relay server 11a is linked to the network electronic device 10 through a link L1a. The relay server 11b is linked to the network electronic device 10 through a link L1b. The relay server 11c is linked to the network electronic device 10 through a link L1c. Specifically, each mail server of the mail servers 12a, 12b, and 12c is linked to the relay server 11a, the relay server 11b, and the relay server 11c. In FIG. 3, the mail server 12a is linked to the relay server 11a, the relay server 11b, and the relay server 11c through a link L2, a link L5, and a link L8 respectively. The mail server 12b is linked to the relay server 11a, the relay server 11b, and the relay server 11c through a link L3, a link L6, and a link L9 respectively. The mail server 12c is linked to the relay server 11a, the relay server 11b, and the relay server 11c through a link L4, a link L7, and a link L10 respectively. The mail server 12a is linked to the second terminal 13 through a link L11. The mail server 12b is linked to the second terminal 13 through a link L12. The mail server 12c is linked to the second terminal 13 through a link L13. Particularly, the query server 15 is linked to all relay servers 11a, 11b, and 11c. In FIG. 3, the query server 15 is linked to the network electronic device 10 through a link Lq. The query server 15 is linked to the relay server 11a through a link L15a. The query server 15 is linked to the relay server 11b through a link L15b. The query server 15 is linked to the relay server 11c through a link L15c. In the embodiment, the mail servers 12a, 12b, and 12c can be considered as a Hotmail server, a Gmail server, or a Hinet server. The Hotmail server, the Gmail server, or the Hinet server is linked to a client terminal (i.e., or say, PC terminal of the subscriber). In the mail data transmission system 200, a mail data can be transmitted from the network electronic device 10 to a specific mail server through an appropriate relay server according to the information inputted to the user interface 14 of the network electronic device 10 and the information reported by the query server 15. The mail data received by the mail server is further transmitted to the second client terminal 13 through a corresponding link. For example, the mail data is transmitted from the network electronic device 10 to the relay server 11b through the link L1b. The relay server 11b transmits the mail data to the mail server 12a (i.e., the mail server to be logged-in) through a link L5. Then, the mail server 12a transmits the mail data to the second client terminal 13 through a link L11. Specifically, the network electronic device 10 can be a network projector in the embodiment. However, the network electronic device 10 is not limited by the network projector in the present invention. For example, the network electronic device 10 can be arbitrary type of electronic device having a capability for accessing network. Configurations of the user interface 14 and the method for transmitting the mail data of the network electronic device 10 in the mail data transmission system 200 are illustrated below.

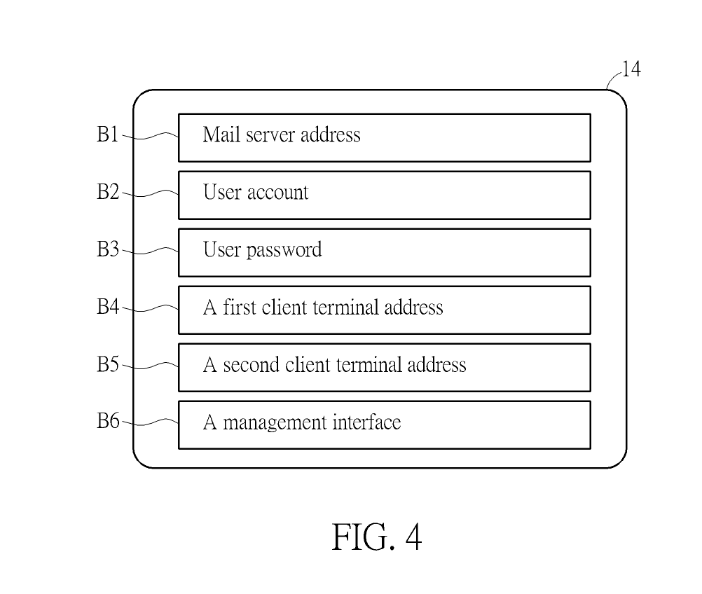

FIG. 4 illustrates the user interface 14 of the network electronic device 10 in FIG. 3. As shown in FIG. 4, the user interface 14 includes 6 input windows, as an input window B1, an input window B2, an input window B3, an input window B4, an input window B5, and an input window B6. Specifically, these input windows B1 to B5 can receive string information from user input. The input window BE is used for displaying a management interface. In the embodiment, the network electronic device 10 is considered as a new-typed network electronic device with 6 input windows. In order to apply the network electronic device 10 to the mail data transmission system 200, 6 input windows B1 to B6 of the user interface 14 are required to input/display the following information. The input window B1 is required to input a network address of a mail server (i.e., for example, the mail server 12a). The input window B2 is required to input a user (i.e., or say, a first client/subscriber) account information. The input window B3 is required to input the user (i.e., or say, the first client/subscriber) password. The input window B4 is required to input a first client terminal address. The first client terminal address can be an E-mail address of the first client. The input window B5 is required to input a second client terminal address. The second client terminal address can be an E-mail address of the second client. The input window BE is a management interface for displaying an available relay server list.

In the following, the method for transmitting the mail data of the mail data transmission system 200 is illustrated. First, 5 input windows B1 to B5 of the user interface 14 are required to input the corresponding information described above. Thus, the network electronic device 10 receives a user account information, a network address of a mail server, a user password, a first client terminal address, and a second client terminal address from the user interface 14. Here, in FIG. 3, the query server 15 generates an available relay server list from the relay servers 11a, 11b, and 11c. Particularly, the query server 15 identifies and acquires at least one relay server address from the plurality of relay servers 11a, 11b, and 11c for generating the available relay server list by using a link response signal with respect to ping signals, a user datagram protocol (UDP), and/or a transmission control protocol (TCP). In FIG. 3, since the query server 15 is linked to the network electronic device 10 through a link Lq, the available relay server list generated by the query server 15 can be transmitted to the network electronic device 10 back through the link Lq. Then, the available relay server list is displayed on the input window BE of the user interface 14. In the embodiment, the query server 15 transmits the available relay server list to the network electronic device 10 after booting up the network electronic device 10. The query server 15 can also generate and transmit the available relay server list to the network electronic device 10 periodically during a predetermined time interval. In other words, an initial available relay server list is pre-defined in the management interface displayed on the input window BE (i.e., for presentation convenience, the input window BE is called as the management interface BE hereafter). Further, the available relay server list of the management interface BE can be updated periodically during the predetermined time interval through processing feedback information from the query server 15. For example, when the relay server 11c suffers severe traffic congestion or a link L15c or a link L1c is disconnected, the query server 15 determines that the relay server 11c is unavailable. Then, the available relay server list transmitted by the query server 15 includes the relay servers 11a and 11b (i.e., relay server 11c is unavailable). After the available relay server list is displayed on the management interface B6, the user can choose a relay server manually from the management interface B6. A relay server can be also selected automatically from the available relay server list according to a built-in decision rule (i.e., for example, relay server can be selected in sequential) of the network electronic device 10.

In the embodiment, when the available relay server list is considered to include the relay server 11a and the relay server 11b, the network electronic device 10 may firstly use the relay server 11a to transmit the mail data from a first client terminal address to the relay server 11a. Specifically, when the relay server 11a suffers a transmission error, the relay server 11a reports an error message (error log message) to the network electronic device 10. Here, the transmission error can be defined as a network traffic congestion status, a response timeout status, or a traffic interruption status. After receiving the error message by the network electronic device 10, the network electronic device 10 retransmits the mail data to another available relay server listed in the available relay server list. In the embodiment, the network electronic device 10 retransmits the mail data to the relay server 11b. Then, the relay server 11b transmits the received mail data to a mail server corresponding to the mail server address. For example, an active mail server 12a to be logged-in with a corresponding mail server address “msa.hinet.net” is used. Then, the relay server 11b transmits the received mail data to a Hinet mail server (i.e., the mail server 12a) through a link L5. Finally, the mail server 12a transmits the mail data to a second client terminal 13 through a link L11. Here, the mail data is transmitted from the network electronic device 10 to the relay server 11b. The relay server 11b executes an encryption process to the mail data before the mail data is transmitted to the mail server 12a corresponding to the mail server address by the relay server 11b, wherein the encryption process is defined according to an encryption standard of the mail server 12a. Thus, when the relay server 11b transmits an encrypted mail data to the mail server 12a, the mail data can be completely received by the mail server 12a without any information loss since the security mechanisms between the relay server 11b and the mail server 12a are matched. Finally, the mail server 12a transmits the encrypted mail data to the second client terminal 13. Thus, in the embodiment, although the network electronic device 10 is the new-typed network electronic device, the network electronic device 10 can transmit the mail data without requiring any modification of the firmware and the database of encryption mechanism in conjunction with high mail data delivery reliability. Additionally, the number of mail servers in the mail data transmission system 200 is equal to 3. The number of relay servers in the mail data transmission system 200 is equal to 3. However, the number of mail servers and the number of relay servers in the mail data transmission system is not limited to 3 in the present invention. For example, in other embodiments, the number of mail servers in the mail data transmission system is equal to N. The number of relay servers in the mail data transmission system is equal to M, wherein N and M are two positive integers.

To sum up, the present invention discloses a mail data transmission system and a mail data transmission method. The mail data transmission method can be applied to early model-typed or new-typed network electronic devices. The idea of the mail data transmission method is to introduce a relay server for transmitting the mail data to a mail server. Specifically, a security verification mechanism and an encryption/decryption process of the relay server are updated synchronously with a mail server. When the mail data is transmitted to the relay server, the relay server executes an encryption process to the mail data before the mail data is transmitted to the mail server. Since the security verification mechanism and the encryption/decryption process are synchronized between the relay server and the mail server, the mail data can be completely received by the mail server through the relay server without any information loss (i.e., for example, mail data may be dropped in conventional method). As a result, high mail data delivery reliability in conjunction with high applicability and high operation convenience of the network electronic device can be achieved without requiring any modification of the firmware and the database of encryption mechanism of the network electronic device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A mail data transmission method, comprising:
inputting a first client terminal address to a network electronic device;
assigning a mail server address to the network electronic device under a simple mail transfer protocol (SMTP);
inputting a second client terminal address to the network electronic device;
transmitting mail data from the first client terminal address of the network electronic device to a relay server corresponding to a relay server address;
transmitting the mail data to a mail server corresponding to the mail server address from the relay server; and
transmitting the mail data to the second client terminal address from the mail server.

2. The method of claim 1, further comprising:
assigning the relay server address to the network electronic device under the simple mail transfer protocol.

3. The method of claim 1, further comprising:
inputting a user-input string to the network electronic device;
wherein the user-input string comprises user account information and the mail server address.

4. The method of claim 1, further comprising:
performing an encryption process upon the mail data by the relay server before transmitting the mail data to the mail server corresponding to the mail server address from the relay server;
transmitting encrypted mail data to the mail server from the relay server; and
transmitting the encrypted mail data to the second client terminal address from the mail server;
wherein the encryption process is applied according to an encryption standard of the mail server.

5. The method of claim 1, further comprising:
establishing a link between the network electronic device and a query server; and
generating an available relay server list from a plurality of relay servers by the query server;
wherein the available relay server list comprises at least one relay server address, and the relay server address of the relay server is selected from the available relay server list by the query server.

6. The method of claim 5, wherein the query server generates the available relay server list by identifying and acquiring the at least one relay server address from the plurality of relay servers according to ping signals, a user datagram protocol (UDP), and/or a transmission control protocol (TCP).

7. The method of claim 5, further comprising:
reporting an error message to the network electronic device by the relay server when the mail data is received by the relay server and an unexpected error is occurred; and
retransmitting the mail data from the first client terminal address to another relay server of the plurality of relay servers by the network electronic device after receiving the error message.

8. The method of claim 1, wherein the network electronic device is a network projector.

9. A mail data transmission system, comprising:
a network electronic device having an input interface for inputting information;
a relay server linked to the network electronic device; and
a plurality of mail servers, each mail server of the plurality of mail servers being linked to the relay server;
wherein mail data is transmitted from a first client terminal address of the network electronic device to the relay server, an encryption process is performed on the mail data by the relay server to generate encrypted mail data according to an encryption standard of the mail servers, the encrypted mail data is transmitted to a mail server of the mail servers from the relay server, the encrypted mail data is transmitted to a second client terminal address from the mail server.

10. The system of claim 9, wherein the information inputted to the input interface comprises a user account information, a user password information, the first client terminal address, the second client terminal address, a relay server address of the relay server, and a mail server address of the mail server.

11. The system of claim 9, wherein the input interface comprises a blank space, and the blank space is used for inputting a user-input string of the user account information and the mail server address.

12. The system of claim 9, further comprising:
a query server linked to the network electronic device for generating an available relay server list from a plurality of relay servers;
wherein the available relay server list comprises at least one relay server address, and a relay server address of the relay server is selected from the available relay server list by the query server.

13. The system of claim 12, wherein the network electronic device comprises a management interface for displaying the available relay server list.

14. The system of claim 12, wherein the information inputted to the input interface comprises a user account information, a user password information, the first client terminal address, the second client terminal address, and a mail server address of the mail server.

15. The system of claim 9, wherein the network electronic device is a network projector.
